(19) United States
(12) Patent Application Publication
(10) Pub. No.: US 2004/0028853 A1
(43) Pub. Date: Feb. 12, 2004

(54) Disposable covering for planar articles with integral, bag-like refuse receptacle

(76) Inventor: Valerie D. Jackson, Baltimore, MD (US)

Correspondence Address: Royal W. Craig, Law Offices of Royal W. Craig, Suite 153, 10 N. Calvert Street, Baltimore, MD, 21202, US

(21) Appl. No.: 10/214,807

(22) Filed: Aug. 7, 2002

(51) Int. Cl. B32B 1/02

(52) U.S. Cl. 428/35.5; 428/35.2

(57) ABSTRACT

Disclosed herein are disposable coverings for planar articles equipped with integral, detachable or non-detachable, refuse receptacles. The present invention generally comprises a rectangular top sheet that serves as the disposable covering and a bag-like refuse receptacle attached along either the underside or topside of the sheet. The top sheet and receptacle are typically fabricated of strong, plastic materials. The dimensions of the disposable covering may be varied to suit a wide range of applications and configurations (e.g. round or square top sheets may be utilized). The present invention's design is simple and straightforward, and can be economically manufactured and sold. In use, the refuse receptacle of the present invention is typically folded and tightly compressed with one end of the receptacle attached to the top sheet along a perforated seam. When it is time to dispose of that which is on the top sheet (e.g. in a picnic scenario, paper plates/cups/plastic tableware), the receptacle is pulled out from beneath the top sheet and opened. Each end of the top sheet may then be gathered up at the corners and rolled toward the receptacle, thereby retaining the aforementioned items. The top sheet and receptacle may then be separated along the perforated seam. The rolled up top sheet and the articles retained therein may then be placed within the receptacle, and the receptacle may be closed and sealed for disposal.

### BACKGROUND OF THE INVENTION

1. Field of the Invention

The present invention relates to coverings for planar articles and, more particularly, to disposable coverings with integral, bag-like refuse receptacles that facilitate the rapid clean up and disposal of the covering and any associated refuse.

2. Description of the Background

There exists a wide variety of planar articles, subject to frequent use/reuse, that must be cleaned (i.e. the removal/disposal of items resident on said planar articles) between each use/reuse cycle. In many instances, the time required by the cleaning process would be significantly minimized by the utilization of a disposable covering that may be attached to the planar article during its use, then easily removed/replaced to facilitate its reuse. Two examples of planar articles to which this concept is especially applicable are picnic tables intended for public use and hospital/nursing home beds.

The tables provided for picnicking in public parks, etc. are generally dirty, weathered, or both. Under those circumstances, most individuals prefer to make use of some form of table covering such as a linen tablecloth. After gathering the tableware and utensils at the conclusion of the picnic, the tablecloth is often shaken to remove accumulated food particles resulting in the littering of the area. Moreover, the tablecloth will typically require washing before it can be reused. The use of disposable tableware/utensils/cups during a picnic is a common occurrence in today's society and the appropriate disposal of those implements, as well as other food and beverage containers, is a tiresome task often requiring several trips to a waste basket or other disposal location.

The present inventor is not the first to address the need for a convenient means to clean up after, for example, a picnic. An example of an apparatus designed for this purpose is found in U.S. Pat. No. 4,542,050 to Gallant. Gallant discloses a table covering comprising a generally planar sheet to be placed on a table top, during the eating of a meal, with an integrally formed bag-like structure secured at one edge of the sheet. The bag-like structure constitutes a garbage bag in which the sheet and the remains of the meal can be placed for proper disposal. Methods of making the covering from tubular stock are also disclosed. Unfortunately, the Gallant patent is drawn specifically to a table covering with a permanently attached bag structure. This permanently attached configuration presents something of a challenge during the clean up procedure. The table covering must be gathered up in a specific manner in order to facilitate its “folding” into the bag structure along with all of the items that were sitting on it.

Hospital and/or nursing home bed coverings are subject to frequent changing due to circumstances such as patient turnover or incontinence. Soiled bed coverings are either washed, for reuse, or thrown away. For a variety of reasons including labor savings (i.e. labor associated with the collection/washing of dirty linens, and the distribution of clean bed linens) and avoidance of potential disease transmittal (i.e. via improperly cleaned linens), a significant number of patient care facilities now utilize disposable bed coverings.

The present inventor is not the first to address the need for disposable bed coverings that are convenient to use. Examples of related apparatus may be found in U.S. Pat. Nos. 5,718,009 to Lin and 5,081,729 to Menday.

U.S. Pat. No. 5,718,009 to Lin discloses a continuous bedclothes device that includes an elongated sheet and a delivery roller. The elongated sheet is made of disposable and recyclable material. The sheet is rolled on the delivery roller and has a plurality of parallel, transverse dividing lines evenly positioned along the length of the sheet. The parallel lines divide the elongated sheet into a plurality bedclothes units of the same length and width. The continuous bedclothes device further comprises a delivery device including a housing and a pair of supporting axles. The housing has a slit adapted for the delivery of the sheet and a pair of supporting axles that are affixed to two opposite sides of the housing so as to support the delivery roller in a rotating manner.

U.S. Pat. No. 5,081,729 to Menday discloses a disposable fitted birthing sheet that consists of a covering having a contoured shape to fit about a mattress. A first mechanism is in the bottom surface of the covering for providing an access so that the mattress can fit into the covering. A second mechanism is in the top surface of the covering, for keeping a patient dry and infection free during the pre-birthing and birthing process.

Unfortunately, disposing of either of these disposable bed coverings requires the user to place the article in an appropriate collection bin, or to obtain, usually from a third party or a remote location, an appropriate refuse receptacle (i.e. trash bag).

Therefore, there remains a need for improved disposable coverings for planar articles, possessing integral, yet readily detachable refuse receptacles, that provide an increased degree of utility during the clean up or changeover process. An apparatus of this type should possess a convenient, foolproof means for separating the disposable covering from the receptacle to facilitate, for example, the gathering up of any associated disposable implements/tableware, or the containment of human/biologic waste, prior to placement in the receptacle. The apparatus should be economical to manufacture and sell to provide for widespread use.

### SUMMARY OF THE INVENTION

It is, therefore, the primary object of the present invention to provide improved disposable coverings for planar articles with integral refuse receptacles.

It is another object of the present invention to provide improved disposable coverings for planar articles wherein the integral refuse receptacles are easily detachable to facilitate their loading.

It is still another object of the present invention to provide improved disposable coverings for planar articles that may be varied in size and shape to suit a wide range of applications.

Yet another object of the present invention is to provide improved disposable coverings for planar articles that are fabricated of strong, lightweight materials appropriate to the nature of their usage.

Still another object of the present invention is to provide improved disposable coverings for planar articles with integral refuse receptacles that are economical to manufacture and sell.

These and other objects are accomplished by disposable coverings for planar articles that are equipped with integral, detachable refuse receptacles. The present invention generally comprises a rectangular top sheet that serves as the covering for the planar article and a bag-like refuse receptacle attached to the underside of the sheet. The receptacle's opening may include a drawstring, or an interior adhesive strip/lining, for use in tightly sealing the receptacle prior to disposal. The top sheet and receptacle are typically fabricated of strong, plastic materials. The dimensions of the disposable coverings may be varied to suit a wide range of applications and configurations (e.g. round or square top sheets may be utilized). The present invention's design is simple and straightforward, and can be economically manufactured and sold. Applications for the present invention, in addition to picnic tables and hospital/nursing home beds, include a painter's drop cloth, a physician's examination table, arts/crafts work areas, and restaurant tables (e.g. crab houses in particular).

In use, the refuse receptacle of the present invention is attached to the underside of the top sheet. It is typically folded and tightly compressed with one end of the receptacle attached to the top sheet along a perforated seam and a second end secured by an adhesive tab. Alternatively, the receptacle may hang along a side or an end of the table or bed while the top sheet is being used. When it is time to dispose of that which is on the top sheet (e.g. paper plates/cups/plastic tableware, human/biologic waste), the receptacle is pulled out from beneath the top sheet and opened. Each end of the top sheet may then be gathered up at the corners and rolled toward the receptacle, thereby retaining the aforementioned items. The top sheet and receptacle may then be separated along the perforated seam. The rolled up top sheet and the articles retained therein may then be placed within the receptacle, and the receptacle may be closed and sealed for disposal.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a top perspective view of a disposable covering 20, for a planar article such as a picnic table, according to a first embodiment of the present invention.

FIG. 2 is a side perspective view of the disposable covering 20 of FIG. 1.

FIG. 3 is an oblique perspective view of a disposable covering 20 shown in use as a cover for a picnic table 100.

FIG. 4 is an oblique perspective view of the disposable covering 20 of FIG. 3 showing the position of a refuse receptacle 60 attached to the underside of a top sheet 40.

FIG. 5 is an oblique perspective view of the disposable covering 20 of FIGS. 3 and 4 showing the refuse receptacle 60 in an open position.

FIG. 6 is an oblique perspective view of the disposable covering 20 of FIGS. 3-5 showing the top sheet 40 being gathered up prior to placement in the receptacle 60.

FIG. 7 is an oblique perspective view of the disposable covering 20 of FIGS. 3-6 showing the refuse receptacle 60 being closed for disposal.

FIG. 8 is an oblique perspective view of a disposable covering 80, for a planar article such as a hospital bed, according to an alternative embodiment of the present invention.

FIG. 9 is an oblique perspective view of a disposable covering 80a, for a planar article such as a hospital bed, according to another alternative embodiment of the present invention.

FIG. 10 is an oblique perspective view of the disposable covering 80 of FIG. 8 showing a top sheet 84 being gathered up prior to placement in a refuse receptacle 82.

FIG. 11 is an oblique perspective view of the disposable covering 80 of FIGS. 8 and 10 showing the refuse receptacle 82 being closed for disposal.

### DETAILED DESCRIPTION OF THE PREFERRED EMBODIMENT

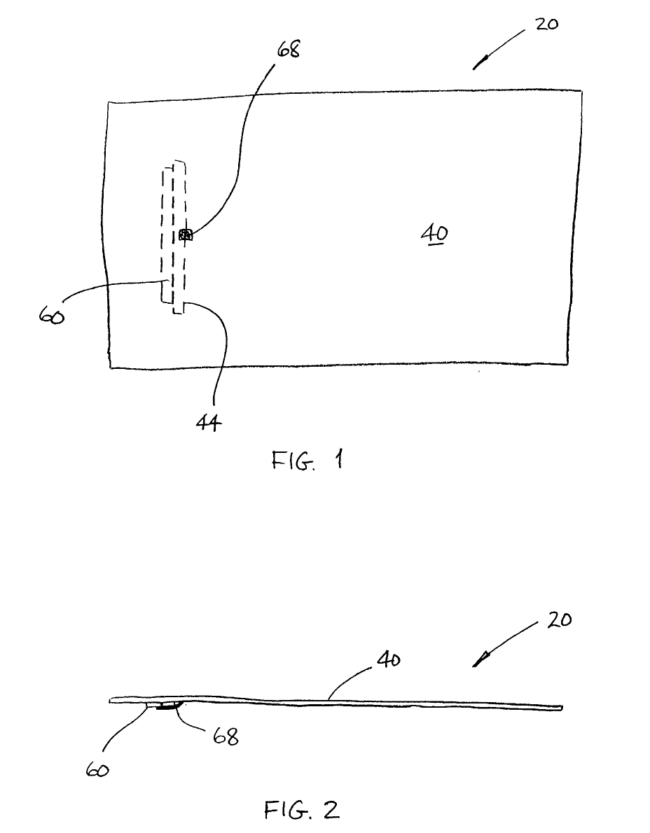

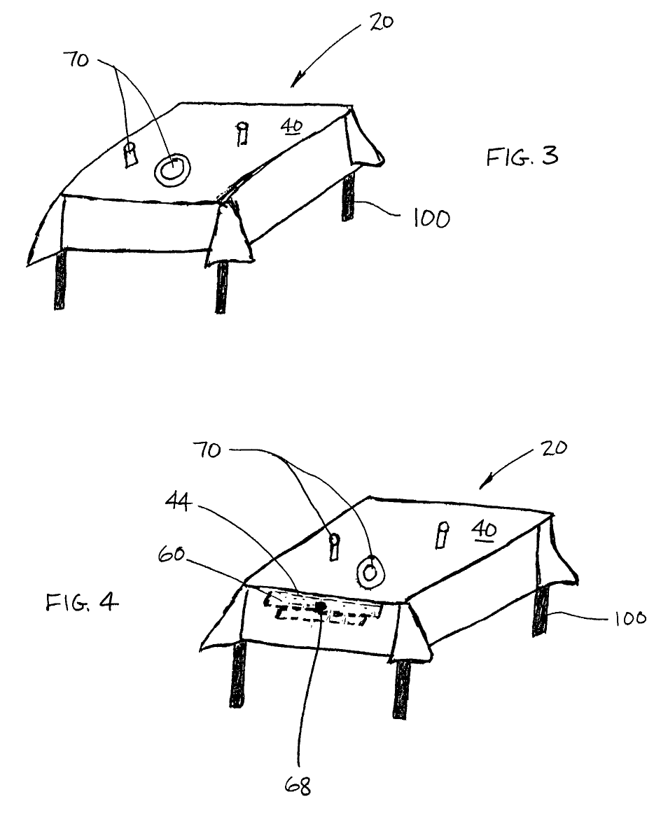

FIGS. 1 and 2 are, respectively, top and side perspective views of a disposable covering 20, for a planar article such as a picnic table, according to a first embodiment of the present invention. The covering 20 generally comprises a top sheet 40 and a refuse receptacle 60 detachably attached along a perforated seam 44. The dimensions of the disposable covering 20 may be varied to suit a wide range of planar article sizes and configurations. The design of the disposable covering 20 is simple and straightforward, and can be economically manufactured and sold.

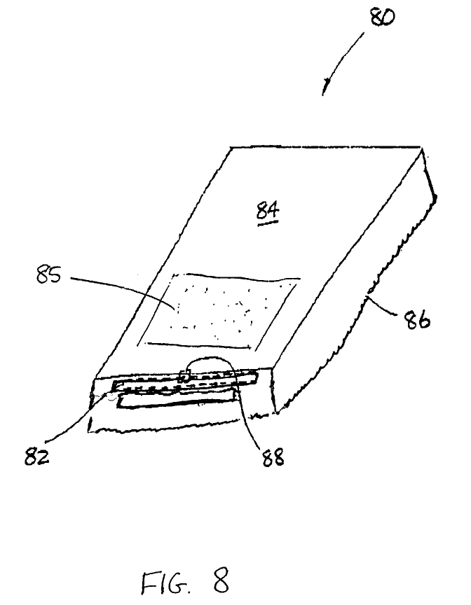

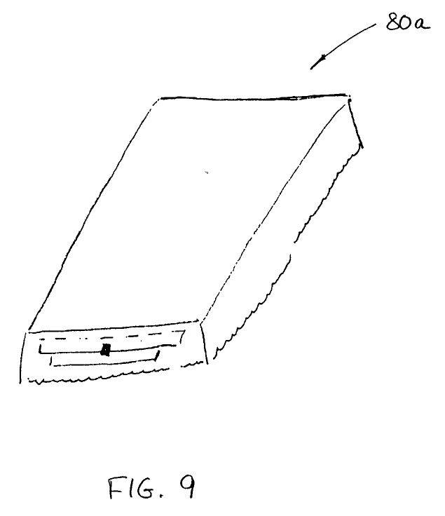

The top sheet 40 is typically rectangular in shape and fabricated of a strong, commercially available plastic, paper, or cloth/fabric material. Alternative embodiments of the present invention may incorporate top sheet 40 shapes other than rectangular (e.g. round or square top sheets may be utilized). The top sheet may possess plain edges or an elastic border or perimeter such as that found on a fitted bed sheet. In addition to the obvious usefulness of an elastic border in attaching a disposable covering 80 (see FIG. 8) to a bed, its presence may also be beneficial in keeping disposable coverings of all shapes and sizes temporarily affixed to all manner of planar articles.

The receptacle 60 is a bag-like structure that is also typically fabricated of a strong, commercially available plastic material such as polypropylene or polyethylene. The receptacle 60 is detachably attached to the top sheet 40 along a perforated seam 44. The perforated seam 44 facilitates the quick and reliable detachment of the receptacle 60 from the top sheet 40. The receptacle's opening 62 (see FIG. 7) may include a drawstring 64, or an interior adhesive strip or lining, for use in tightly sealing the receptacle 60 for disposal. Alternatively, the refuse receptacle 60 may be fixedly attached to the sheet 40.

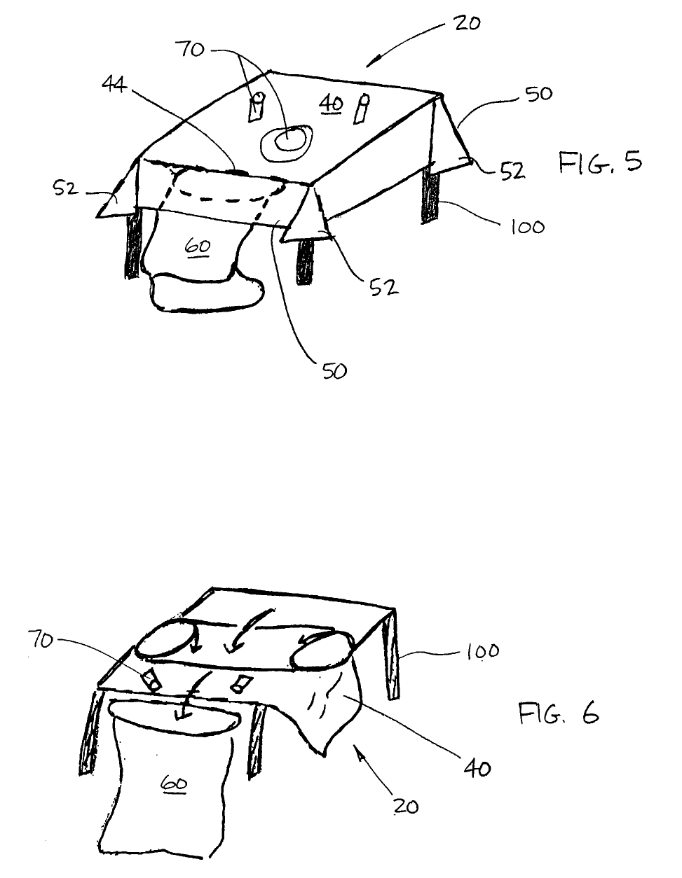

FIG. 3 is an oblique perspective view of a disposable covering 20, according to a first embodiment of the present invention, shown covering a picnic table 100. FIGS. 4-7 are a series of oblique perspective views of the disposable covering 20 of FIG. 3 showing its method of use.

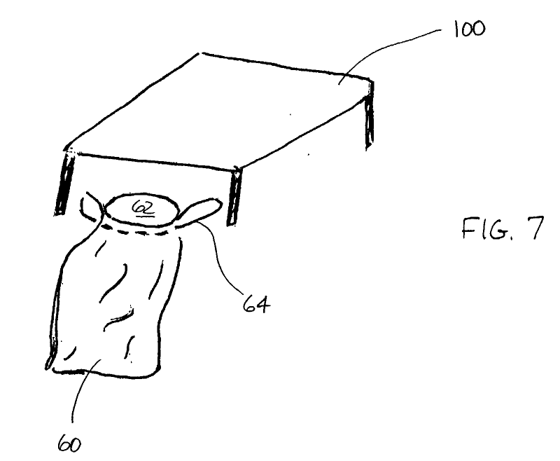

In use, the refuse receptacle 60 may be attached to the underside of the top sheet 40 as shown in FIG. 4. The receptacle 60 may be folded and tightly compressed with one end attached to the top sheet 40 along a perforated seam 44 and a second end secured by an adhesive tab 68 (see also FIGS. 1 and 2). Alternatively, the receptacle 60 may hang along an end of a table while the top sheet 40 is being used as a table covering. When it is time to dispose of any articles 70 located on the top sheet 40 (e.g. paper plates/cups, plastic knives/forks/spoons), the receptacle 60 is pulled out from beneath the top sheet 40 and opened by removing the adhesive tab 68 (i.e. allowing the receptacle 60 to achieve the position shown in FIG. 5). Each end 50 of the top sheet 40 may then be gathered up at the corners 52 and rolled toward the receptacle 60 (see FIG. 6), thereby retaining the aforementioned articles 70. The top sheet 40 and the receptacle 60 may then be separated along the perforated seam 44. Detachment of the receptacle 60 from the top sheet 40 is accomplished by exerting a pulling force perpendicular to the perforated seam 44. The perforated seam 44 provides a clean line of separation between the receptacle 60 and the top sheet 40. The rolled up top sheet 40 and the articles 70 retained therein may then be placed within the receptacle 60. As shown in FIG. 7, the receptacle's opening 62 is then sealed by means of the drawstring 64, or adhesive strip, for disposal.

The alternative embodiment of the present invention shown in FIG. 8 is a disposable covering 80 for use on, for example, a hospital/nursing home bed. The covering 80 is shown with an integral absorbent pad 85, an elastic border or perimeter 86, and a refuse receptacle 82 that is attached to the topside of a rectangular top sheet 84. The receptacle 82 may be held in its folded and tightly compressed position by an adhesive tab 88. This alternative embodiment may be utilized on beds found in a wide variety of facilities (e.g. hotels, motels, lodges).

FIG. 9 shows yet another alternative embodiment of a disposable covering 80a (i.e. an embodiment that is identical to that of FIG. 8 except for the deletion of the integral absorbent pad).

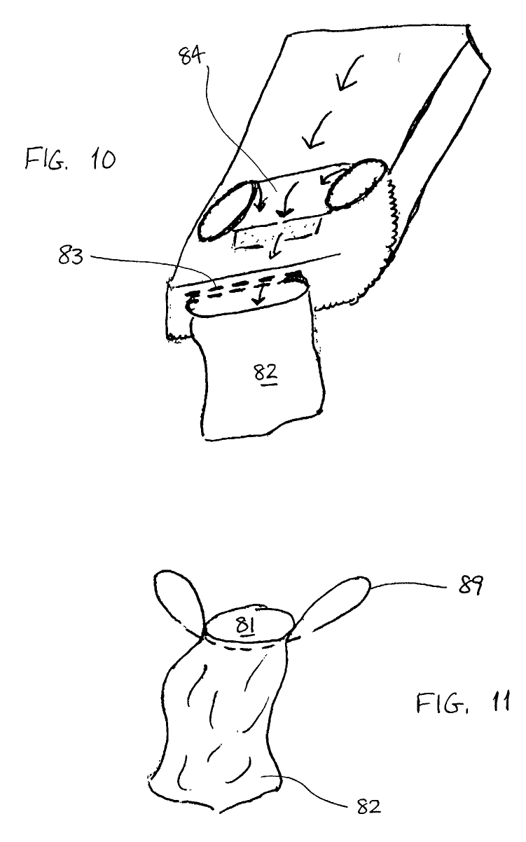

The method of using the alternative covering 80, shown in FIGS. 10 and 11, is very similar to that described above in association with the disposable table covering 20. When the disposable covering 80 is to be removed/replaced, the adhesive tab 88 holding the receptacle 82 in its folded/compressed position is removed. The receptacle 82 is detached from the top sheet 84 along a perforated seam 83 and unfolded (see FIG. 10). The top sheet 84 with any associated debris/waste is gathered up by working from the ends of the top sheet 84 toward its midpoint. The rolled up top sheet 84 and accumulated waste are then placed in the receptacle 82. As shown in FIG. 11, the receptacle's opening 81 is then sealed by means of a drawstring 89 or an adhesive strip for disposal.

With respect to FIGS. 1-11, as is readily perceived in the foregoing description, the design of the disposable coverings 20, 80, 80a utilizes strong, lightweight materials to provide the durability required by the nature of its usage, is simple and straightforward, and may be economically manufactured and sold. The flexible design (i.e. dimensions/volume, configuration) of the disposable coverings 20, 80, 80a for planar articles allows for use in a wide variety of applications.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A disposable covering for planar articles subject to multiple use/reuse cycles, comprising:
a generally planar sheet to be laid on the top surface of a planar article; and
a bag-like receptacle formed integrally with said sheet and detachably attached along a seam in a surface of said sheet, said receptacle having an opening formed along said seam;
whereby said receptacle is detached from said sheet along said seam, said sheet and any items lying thereon are gathered up and placed within said receptacle, and said opening of said receptacle is closed.

2. The disposable covering according to claim 1 wherein said sheet is substantially rectangular in shape.

3. The disposable covering according to claim 2 wherein said receptacle is detachably attached along a seam in the bottom surface of said substantially rectangular sheet.

4. The disposable covering according to claim 2 wherein said receptacle is detachably attached along a seam in the top surface of said substantially rectangular sheet.

5. The disposable covering according to claim 2 wherein said sheet is formed with an elastic perimeter.

6. The disposable covering according to claim 1 wherein said sheet is substantially square in shape.

7. The disposable covering according to claim 1 wherein said sheet is substantially circular in shape.

8. The disposable covering according to claim 1 wherein said opening of said receptacle further comprises an adhesive strip.

9. The disposable covering according to claim 1 wherein said opening of said receptacle further comprises a drawstring.

10. A disposable table cover with integral refuse receptacle, comprising:
a generally planar sheet to be laid atop a top surface of a table; and
a bag-like receptacle formed integrally with said sheet and concealed thereby when said sheet is lying atop said table, said bag-like receptacle having an opening and being attached along one side of said opening to an under surface of said sheet;
whereby said planar sheet and any items lying thereon may be gathered up and stowed within said receptacle, and said opening of said receptacle closed for disposal.

11. The disposable table cover according to claim 10 wherein said sheet is substantially rectangular in shape.

12. The disposable table cover according to claim 10 wherein said sheet is substantially square in shape.

13. The disposable table cover according to claim 10 wherein said sheet is substantially circular in shape.

14. The disposable table cover according to claim 10 wherein said opening of said receptacle further comprises an adhesive strip.

15. The disposable table cover according to claim 10 wherein said opening of said receptacle further comprises a drawstring.
